(19) United States
(12) Patent Application Publication
(10) Pub. No.: US 2025/0060985 A1
(43) Pub. Date: Feb. 20, 2025

(54) I2C LINK MANAGEMENT METHOD AND APPARATUS, DEVICE, AND NONVOLATILE READABLE MEDIUM

(71) Applicant: SUZHOU METABRAIN INTELLIGENT TECHNOLOGY CO., LTD., Suzhou, Jiangsu (CN)

(72) Inventor: Lupan WANG, Suzhou, Jiangsu (CN)

(21) Appl. No.: 18/724,648

(22) PCT Filed: Dec. 23, 2022
(86) PCT No.: PCT/CN2022/141669

§ 371 Date: Jun. 27, 2024

(30) Foreign Application Priority Data
Aug. 18, 2022 (CN) 202210994297.2

(51) Int. Cl. G06F 9/455; G06F 13/42

(52) U.S. Cl. CPC G06F 9/45558; G06F 13/4282; G06F 2009/45579

(57) ABSTRACT

An I2C link management method and apparatus, a device, and a nonvolatile readable medium. The method comprises: packaging and virtualizing an I2C link to obtain a corresponding virtual device (S1); establishing a cascade between the virtual device and a virtual machine, and by means of the virtual machine, controlling the virtual device to perform verification, and in response to the verification having passed, acquiring an initial state number corresponding to the virtual device (S2); updating the state of the virtual device on the basis of a change occurring during the operation of the virtual device, so as to obtain an updated state (S3); and managing the initial state number and adding an offset corresponding to the updated state and recording same, and establishing a response of the virtual machine to the offset corresponding to the updated state, so as to achieve management of the I2C link (S4). The present method ensures that anomaly problems can be more conveniently handled for I2C links, thus improving the quality of I2C links on mainboards, and achieving efficient operation of storage devices.

### CROSS-REFERENCE TO RELATED APPLICATION

This application claims priority to Chinese patent application No. 202210994297.2, titled “METHOD AND APPARATUS FOR MANAGING INTER-INTEGRATED CIRCUIT LINK. DEVICE AND READABLE MEDIUM”, filed on Aug. 18, 2022 before the China National Intellectual Property Administration, which is incorporated herein in its entirety by reference.

### TECHNICAL FIELD

The application relates to the field of Inter-Integrated Circuit (12C) links, and more particularly relates to a method and apparatus for managing an I2C link, a device and a non-transitory readable medium.

### BACKGROUND

In the era of big data, higher requirements are placed on the reliability of a storage array, requiring that all load chips on a storage device operate normally and respond to issues arose at a load end in a timely manner. The I2C (Inter-Integrated Circuit, a bidirectional two-wire synchronous serial bus), as an important state management bus on a storage mainboard, can summarize information such as an operation state of a load to a baseboard management controller (BMC) unit to manage a load device. Therefore, the normal operation of the I2C link is crucial to the normal operation of the load.

### SUMMARY

In view of the above, the present disclosure provides a method and apparatus for managing an I2C link, a device and a readable medium.

In view of the above object, an aspect of embodiments of the disclosure provides a method for managing an I2C link. The method includes the following steps: obtaining a corresponding virtual device by packing and virtualizing the I2C link: establishing a cascade between the virtual device and a virtual machine, controlling, by the virtual machine, the virtual device to undergo verification, and acquiring an initial state number corresponding to the virtual device in response to having passed the verification: updating a state of the virtual device according to changes of the virtual device occurred during operation of the virtual device to obtain an updated state; and managing the initial state number, adding an offset corresponding to the updated state and recording the offset, and establishing a response of the virtual machine to the offset corresponding to the updated state to manage the I2C link.

In some embodiments, the step of obtaining a corresponding virtual device by packing and virtualizing the I2C link includes: acquiring parameter information about the I2C link; and packing and virtualizing the parameter information and the I2C link to obtain a virtualized device parameter and the virtual device.

In some embodiments, the step of acquiring parameter information about the I2C link includes: acquiring parameter information about an internal state of the I2C link, including operating modes, timing sequence parameters for various operating modes, and a transmission state of a data bus; and acquiring parameter information about an external circuit of the I2C link, including a bus transmission rate, pin configuration and external pull-up resistor conditions, presence conditions of slave devices, and a running state of an I2C SWITCH in case of multiple slave devices.

In some embodiments, the step of establishing a cascade between the virtual device and a virtual machine, controlling, by the virtual machine, the virtual device to undergo verification, and acquiring an initial state number corresponding to the virtual device in response to having passed the verification includes: storing the virtualized device parameter in the virtual machine; performing cascade classification according to a data transmission capability parameter of the virtual device and a function of a device connected to the I2C link to establish the cascade between the virtual machine and the virtual device; and verifying, by the virtual machine, the virtual device based on the cascade, and acquiring the initial state number corresponding to the virtual device in response to the virtual machine matching the virtual device.

In some embodiments, the step of verifying, by the virtual machine, the virtual device based on the cascade, and acquiring the initial state number corresponding to the virtual device in response to the virtual machine matching the virtual device includes: setting a period for verifying the virtual device by the virtual machine, and determining whether a parameter of the virtual device satisfies a required index within the period; adjusting the parameter of the virtual device in response to the parameter of the virtual device not satisfying the required index; and assigning a corresponding state parameter number to the virtual device as the initial state number in response to the parameter of the virtual device satisfying the required index.

In some embodiments, the step of setting a period for verifying the virtual device by the virtual machine, and determining whether a parameter of the virtual device satisfies a required index within the period includes: determining whether a machine-side link signal of the I2C link is in place; and determining whether a transmission rate of the I2C link matches a transmission rate of a current mode.

In some embodiments, the step of updating a state of the virtual device according to changes of the virtual device occurred during operation of the virtual device, and obtaining an updated state includes: acquiring a corresponding virtualized device parameter during the operation of the virtual device in real time, and taking the virtualized device parameter as an operation parameter of the virtual device; and updating the state of the virtual device based on changes of the operation parameter to obtain the updated state.

In some embodiments, the step of managing the initial state number, adding an offset corresponding to the updated state and recording the offset, and establishing a response of the virtual machine to the offset corresponding to the updated state to manage the I2C link includes:
creating a state number management unit to manage various updated states of the virtual device; and
establishing responses of the virtual machine to offsets corresponding to various updated states of the virtual device to manage the I2C link.

In some embodiments, the step of creating a state number management unit to manage various updated states of the virtual device includes: providing, in the state number management unit, an offset unit for abnormities during operation and an offset unit for states during operation to respectively match an abnormal updated state and a normal updated state of the virtual device.

In some embodiments, the step of creating a state number management unit to manage various updated states of the virtual device further includes: updating a state offset in the offset unit for states during operation in response to the updated state of the virtual device being the normal updated state; and in response to the updated state of the virtual device being a known abnormal updated state, addressing an abnormal offset corresponding to the known abnormal updated state in the offset unit for abnormities, and executing a corresponding processing measure.

In some embodiments, the step of creating a state number management unit to manage various updated states of the virtual device further includes: in response to the updated state of the virtual device being an unknown abnormal updated state, updating the abnormal offset in the offset unit for abnormities during operation and recording the abnormal offset.

In some embodiments, the step of in response to the updated state of the virtual device being an unknown abnormal updated state, updating the abnormal offset in the offset unit for abnormities during operation and recording the abnormal offset includes: recording the updated abnormal offset in the offset unit for abnormities, and providing a corresponding abnormal offset for the virtual device in the same abnormal updated state; and recording the updated abnormal offset in a pre-operation abnormity unit to avoid the occurrence of the abnormal updated state of the virtual device prior to the operation.

Another aspect of embodiments of the present disclosure further provides an apparatus for managing an Inter-Integrated Circuit (I2C) link, including: a first module configured for obtaining a corresponding virtual device by packing and virtualizing the I2C link; a second module configured for establishing a cascade between the virtual device and a virtual machine, controlling, by the virtual machine, the virtual device to undergo verification, and acquiring an initial state number corresponding to the virtual device in response to passing the verification; a third module configured for updating a state of the virtual device in response to changes of the virtual device occurred during operation of the virtual device, and obtaining an updated state; and a fourth module configured for managing the initial state number, adding an offset corresponding to the updated state and recording the offset, and establishing a response of the virtual machine to the offset corresponding to the updated state to manage the I2C link.

Another aspect of embodiments of the present disclosure further provides a computer device, including: at least one processor; and a memory storing computer instructions executable on the processor, wherein the instructions, when executed by the processor, implement steps of any of the methods described above.

Another aspect of embodiments of the present disclosure further provides a non-transitory computer readable storage medium storing a computer program that, when executed by a processor, implements steps of any of the methods described above.

### BRIEF DESCRIPTION OF THE DRAWINGS

In order to explain technical solutions in embodiments of the disclosure or the related art more clearly, a brief introduction will be given to accompanying drawings to be used in the description of the embodiments or the related art. Apparently, the accompanying drawings in the description below are only intended for some embodiments of the disclosure. For those ordinarily skilled in the art, other examples may also be obtained according to these accompanying drawings without involving any creative effort.

FIG. 1 is a schematic diagram of a method for managing an I2C link provided by an embodiment of the disclosure;

FIG. 2 is a schematic diagram of a method for managing an I2C link provided by another embodiment of the disclosure;

FIG. 3 is a schematic diagram illustrating a part of establishing and preparing virtualization of the I2C in the method for managing the I2C link provided by the disclosure;

FIG. 4 is a schematic diagram illustrating a part of verifying and managing virtual devices of the I2C in the method for managing the I2C link provided by the disclosure;

FIG. 5 is a schematic diagram of a state number management unit of the method for managing the I2C link provided by the disclosure;

FIG. 6 is a schematic diagram of an apparatus for managing an I2C link provided by an embodiment of the disclosure;

FIG. 7 is a schematic diagram of a computer device provided by an embodiment of the disclosure; and

FIG. 8 is a schematic diagram of a non-transitory computer readable storage medium provided by an embodiment of the disclosure.

### DETAILED DESCRIPTION OF THE EMBODIMENTS

Embodiments of the disclosure are described below. However, it should be understood that the embodiments provided are merely exemplary, and various alternative forms may be adopted in other embodiments.

In addition, it should be noted that expressions “first” and “second” used throughout the embodiments of the disclosure are used for distinguishing two different entities or different parameters with the same name. As can be seen, “first” and “second” are merely used for the convenience of expressions, and should not be understood as limiting the embodiments of the disclosure, which will not be described one by one in the subsequent embodiments. The terms “including”, “comprising”, or any other variations thereof, are intended to cover a non-exclusive inclusion, so that a process, method, article, or apparatus containing a series of elements not only includes those elements, but also may include other elements which are not expressly listed or inherent to such process, method, article, or apparatus.

One or more embodiments of the disclosure will be described below with reference to the accompanying drawings.

In the related art, the I2C link is merely used as an intermediary tool for detecting the operation state of the load, and the operation state of the I2C per se, relevant preparations before the operation and solutions for solving problems occurred during operation are ignored by designers. Generally, a current operation state of the I2C is determined based on simple conditions such as an in-place signal and a response signal, and the I2C link itself cannot be better managed, so that the system fails to quickly make a correct response when problems occur in the I2C, and the operation of the load on the I2C link may be affected by the interruption and hang-up of the I2C link.

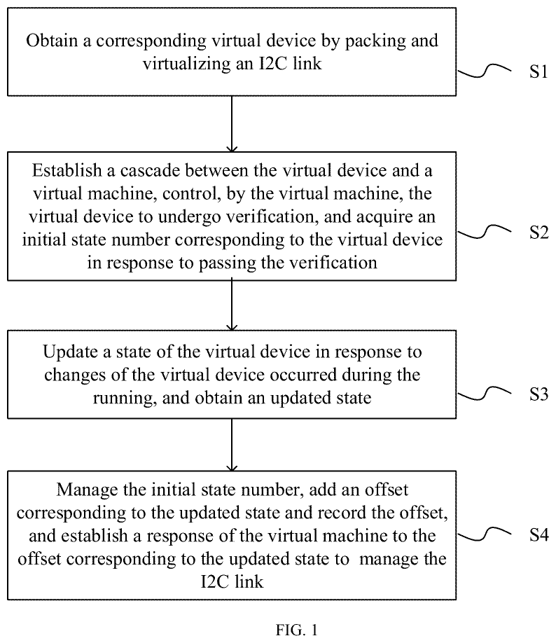

In view of the above object, a first aspect of some embodiments of the disclosure provides a method for managing an inter-integrated circuit (I2C) link. FIG. 1 is a schematic diagram of a method for managing the I2C link provided by an embodiment of the the disclosure. As shown in FIG. 1, the method for managing the I2C link according to some embodiments of the disclosure includes steps described below.
At S1, a corresponding virtual device is obtained by packing and virtualizing the I2C link.
At S2, a cascade between the virtual device and a virtual machine is established, the virtual device is controlled by the virtual machine to undergo verification, and an initial state number corresponding to the virtual device is acquired in response to having passed the verification.
At S3, a state of the virtual device is updated according to changes of the virtual device occurred during the operation of the virtual device, and an updated state is obtained.
At S4, the initial state number is managed, an offset corresponding to the updated state is added and recorded, and a response of the virtual machine to the offset corresponding to the updated state is established, so that the management of the I2C link is achieved.

According to the method for managing the I2C link provided by the disclosure, the I2C link in the system is virtualized as the load device for management, so as to achieve systematization and rapidity of management of the I2C device. On the one hand, an operation state of the I2C link is recorded in real time, and the recorded real-time data play a guiding role in optimizing running of a storage system; on the other hand, fault diagnosis is more convenient when the I2C link has problems. By assigning the state number to the I2C link, and recording and managing the state number in real time, the I2C link may be quickly diagnosed after the occurrence of abnormality, and a corresponding solution may be found, thereby improving the reliability of the storage system, ensuring the I2C link to handle the abnormality more conveniently, improving the quality of the I2C link on the mainboard, and achieving the efficient running of the storage device; and the method provided by the disclosure does not involve the introduction of complicated hardware structures, thereby being simple and convenient to operate, and improving the reliable running of the system without any increase in the cost.

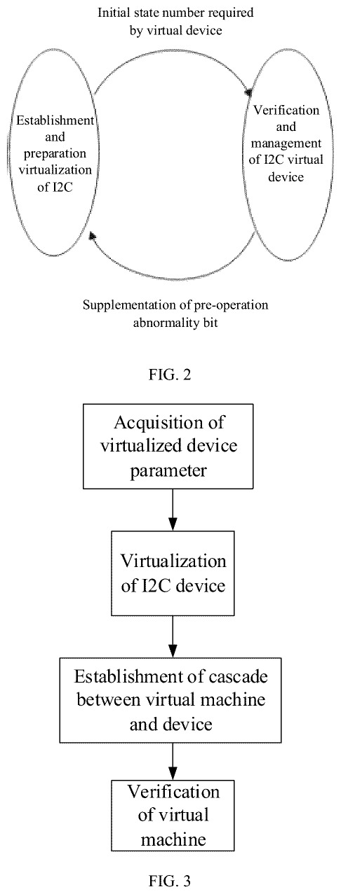

In view of the above object, the first aspect of some embodiments of the disclosure further provides another method for managing the I2C link. As shown in FIG. 2. FIG. 2 is a schematic diagram of a method for managing the I2C link provided by another embodiment of the disclosure.

In some embodiments, the method for managing the I2C link provided by the disclosure includes a part of establishing and preparing virtualization of the I2C prior to the operation of a system and a part of verifying and managing I2C virtual devices during the operation of the system. Before the normal operation of the system, it is required to verify virtual devices (the part of verifying), the system is normally activated after confirming that all the virtual devices operate normally, and an initial state number is assigned to each of the virtual devices; and in an operation process of the system, the virtual machine quickly detects and records state numbers occurred, makes a comparison in time, and quickly responds to abnormalities occurred in the virtual devices, so as to ensure the normal operation of the I2C link. The part of establishing and preparing virtualization of I2C is the basis of the part of verifying and managing the I2C virtual devices during the operation of the system, and provides the part of verifying and managing the I2C virtual devices with the initial state number required for verifying and managing the I2C virtual device. The part of verifying and managing the I2C virtual devices during the operation of the system may also record a new state and an abnormal number of the virtual device after the operation of the system, so as to continuously supplement the parameter information and assignment of the state numbers of the part of establishing and preparing virtualization of I2C prior to the operation, and the two parts complement each other to work for the system. Moreover, through the method for managing a state number of a virtual device using ‘state number plus offset’ provided in an execution process of the above two parts, the virtual machine can perform an addressing operation on the virtual devices quickly during execution. Particularly, the method includes steps described below.

The part of establishing and preparing virtualization of I2C prior to the operation is shown in FIG. 3. FIG. 3 is a schematic diagram illustrating the part of establishing and preparing virtualization of I2C in the method for managing the I2C link provided by the disclosure. Acquiring parameters of the I2C link is the basis of the part of establishing and preparing virtualization of I2C prior to the operation. Relevant parameters of I2C include two parts, namely, internal parameters and external parameters. The internal parameters include relevant properties of an I2C protocol, such as operating modes, timing sequence parameters in various operating modes, and a transmission state on a data bus. The external parameters include relevant properties of a physical layer of the I2C link, such as a bus transmission rate, pin configuration and external pull-up resistor conditions, presence conditions of slave devices, and a running state of an I2C SWITCH in case of multiple slave devices. The I2C link and relevant peripherals thereof as well as the obtained parameters of the I2C link are all packed and virtualized, and after the I2C link is packed and virtualized, all the above parameter information may be virtualized device parameters. The virtual machine is created in the BMC unit, and the I2C link including the virtualized device parameters is packed and encapsulated as a virtual device that is detected and controlled by the virtual machine. In a creation process of the virtual machine, firstly, the above virtualized device parameters and various types of parameter setting information of the I2C link are stored for verification and comparison. The cascade between the virtual machine and the virtual devices is classified according to functions, multiple virtual devices may be cascaded on one virtual machine, and specific cascade conditions need to be classified according to a data transmission capability parameter of the I2C virtual device and a specific function of a device connected to the I2C link, so as to ensure that the virtual machine has an absolute control capability on the link, and avoid an overload phenomenon of the virtual devices, namely, the virtual devices (an IIC virtual device on a CPU and an IIC virtual device on a BBU) with a plurality of state parameter loads are connected to the same virtual machine. After the cascade between the virtual machine and the virtual devices is established, preparation operation is started, namely, the virtual machine controls the virtual device to undergo verification thereof. In the verification process, the virtual machine controls the virtual device to operate for a short time, and checks whether various parameters of the virtual device meet the required indexes. For example, it is determined whether an I2C slave side link signal is in place, if not, it is determined that the virtual device has a fault during the operation; and it is determined whether the transmission rate of the I2C matches the transmission rate of the current mode, if not, it is also determined that the virtual device has a fault during the operation, and adjustment is needed. When all the virtual devices can operate normally, the virtual machine assigns the initial state number to each of the virtual devices, and the part of establishing and preparing virtualization of I2C is completed.

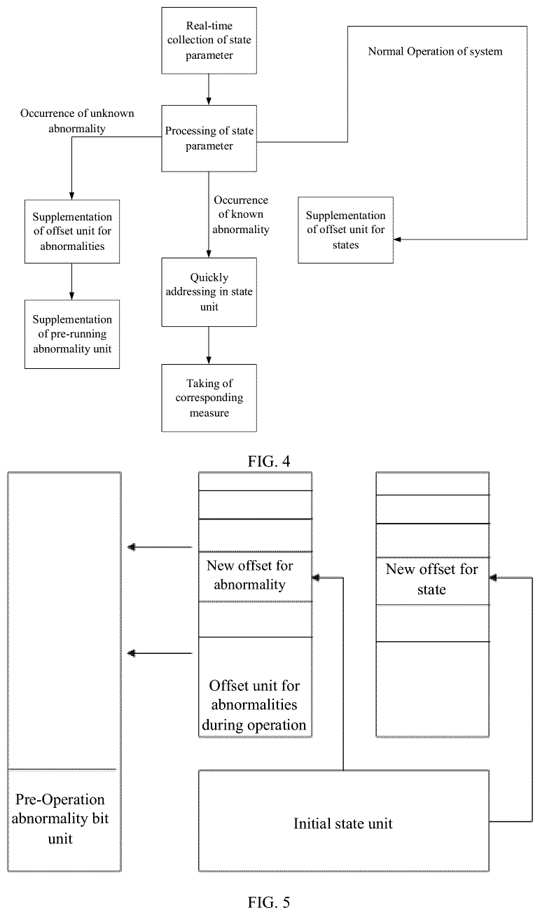

The part of verifying and managing the I2C virtual device in the operation of the system is shown in FIG. 4. FIG. 4 is a schematic diagram illustrating the part of verifying and managing the I2C virtual device in the method for managing the I2C link provided by the disclosure. Relevant data of an internal state and an external circuit of an I2C bus is acquired in real time during the operation of the system, and the acquired data is abstracted as operating parameters of the virtual devices for subsequent processing. The virtual machine compares the acquired operating parameters with preset parameters for creating the virtual machine, and makes adjustment, so as to ensure that the virtualized I2C virtual device operates normally. After the parameters are adjusted, the virtual machine assigns a corresponding state offset to the virtual device in operation. When an abnormity occurs in the I2C, the virtual machine records the state offset under the abnormity, and takes a corresponding measure for handling the fault of the virtual device in a timely manner according to a previous record of the state number.

In some embodiments, a method for managing a state number of a virtual device using ‘state number plus offset’ is provided, so that the virtual machine can make a corresponding response quickly according to the state number provided by the virtual device. Management of the state number includes four parts, an initial state number unit, an offset unit for states during operation, an offset unit for abnormities during operation and a pre-operation abnormity bit unit. The initial state number is a base address state of an in-running state offset and an in-running abnormal offset. To this end, a state number management unit is provided to manage various states of the virtual device. As shown in FIG. 5. FIG. 5 is a schematic diagram illustrating the state number management unit of the method for managing the I2C link provided by the disclosure. The initial state number unit includes two parts, among them, a left part corresponds to the offset unit for abnormities during operation, and a right part corresponds to offset for states during operation. After the normal operating of the system, the same initial state code is assigned to the two parts, and with the data transmission of the I2C link in the operating process, a busy state and a data transmission state of the I2C change accordingly. When the system is in normal operating and a new state occurs, a new state offset is stored in the offset unit for states during operation, and the state offset is defined as the condition that the system is in normal operating and the new state is determined to be a state that has not occurred before in the virtual device. When abnormities such as hang-up occur in the I2C, and these abnormities are not defined in the offset unit for abnormities, the offset unit for abnormities may automatically generate new offsets for the abnormities, processing measures for the abnormities after occurrence of the abnormities correspond to the generated offsets for the abnormities one by one, the virtual machine records the processing measures in a timely manner. When such an abnormity occurs again in the virtual device, the virtual machine may address the previous offset for abnormity in the offset unit for abnormities in a timely manner and execute the previous processing measure. Meanwhile, after the abnormal processing is completed, the virtual machine may automatically compare the conditions of corresponding state offsets before and after the occurrence of one abnormity offset, and try to analyze the root cause of the abnormal problem through a large amount of data and accumulation of conditions. A relationship between the occurrence of the abnormal problem and the current operating state of the virtual device is analyzed to find out the root cause of the abnormal problem, which is conducive to determining, by the virtual machine, the probability of the abnormality according to a change of the state offset in a short time before the abnormal offset appears, thereby avoiding the occurrence of the abnormal problem by fundamentally controlling the operating state of the virtual device. In addition to playing a role in the running process in facilitating that the virtual machine positions the problem and finds out the solution quickly, the abnormity offset may also serve as a supplementation of the pre-operation abnormity bit unit, and problems occurred in the operating process of the I2C virtual device also need to be avoided prior to the operation, thus the abnormity offset of the offset unit for abnormities during operation may be copied and stored in the pre-operation abnormity bit unit.

In some embodiments, prior to the normal operation of the system, the virtual devices are verified, and an initial state number is assigned to each of the virtual devices; in an operating process of the system, the virtual machine quickly detects and records the state number occurred, makes a comparison in a timely manner, and quickly responds to the abnormity of the virtual devices. In this method, the I2C link and relevant peripherals thereof as well as relevant parameters are all virtualized as virtual devices, and the virtual machine is created in the BMC unit to manage corresponding virtual devices. The I2C is ensured to operate normally through verifying parameters of the virtual devices, and the I2C is ensured to handle abnormal problems more conveniently and quickly through recording state numbers, thereby improving the quality of the I2C link on a motherboard, and achieving efficient running of a storage device. In above running and execution processes, a method for managing a state number of a virtual device using ‘state number plus offset’ is provided. According to this method, the virtual machine can perform addressing operation on the virtual device quickly when an algorithm is executed, and the virtual machine may address the offset unit for abnormities and position the problem in a timely manner when abnormities occur in the virtual device.

Further, the method for managing the I2C link provided by the disclosure is not limited to the management of the I2C link stored in a dual controller of a unified storage array, and may also be used for the management of the I2C link on a server and a mainboard of a military computer.

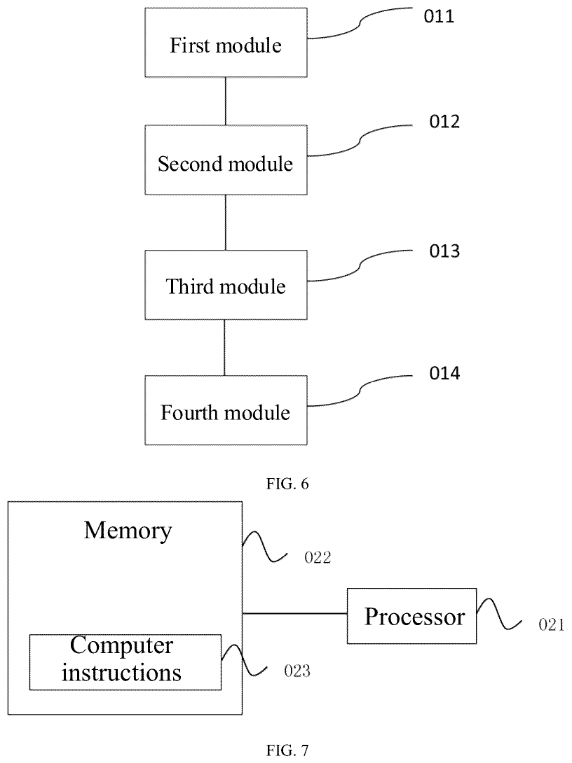

A second aspect of some embodiments of the disclosure provides an apparatus for managing an I2C link. FIG. 6 is a schematic diagram of an apparatus for managing the I2C link provided by an embodiment of the disclosure. As shown in FIG. 6, the apparatus for managing the I2C link provided by the disclosure includes: a first module 011 configured for obtaining a corresponding virtual device by packing and virtualizing the I2C link; a second module 012 configured for establishing a cascade between the virtual device and a virtual machine, controlling, by the virtual machine, the virtual device to undergo a verification, and acquiring an initial state number corresponding to the virtual device in response to having passed the verification; a third module 013 configured for obtaining an updated state by updating a state of the virtual device according to changes of the virtual device occurred during operation of the virtual device; and a fourth module 014 configured for managing the initial state number, adding an offset corresponding to the updated state and recording the offset, and establishing a response of the virtual machine to the offset corresponding to the updated state to manage the I2C link.

In view of the above object, a third aspect of some embodiments of the disclosure provides a computer device. FIG. 7 is a schematic diagram of an example of the computer device provided by the disclosure. As shown in FIG. 7, the example of the computer device provided by the disclosure includes the following modules: at least one processor 021; and a memory 022 storing computer instructions 023 executable on the processor 021.

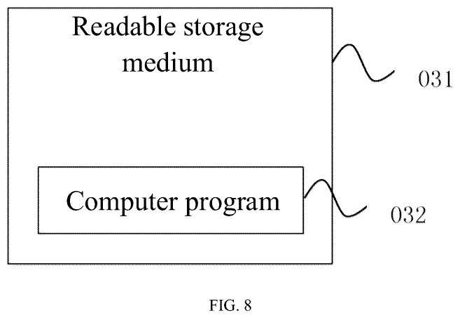

The disclosure further provides a non-transitory computer readable storage medium. FIG. 8 is a schematic diagram of an example of the non-transitory computer readable storage medium provided by the disclosure. As shown in FIG. 8, the non-transitory computer readable storage medium 031 is stored with a computer program 032 that, when executed by a processor, executes the above method. The computer program 032 includes: obtaining a corresponding virtual device by packing and virtualizing an I2C link; establishing a cascade between the virtual device and a virtual machine, controlling, by the virtual machine, the virtual device to undergo a verification, and acquiring an initial state number corresponding to the virtual device in response to having passed the verification; obtaining an updated state by updating a state of the virtual device according to changes of the virtual device occurred during operation of the virtual device; and managing the initial state number, adding an offset corresponding to the updated state and recording the offset, and establishing a response of the virtual machine to the offset corresponding to the updated state to manage the I2C link.

In some embodiments, obtaining a corresponding virtual device by packing and virtualizing the I2C link includes: acquiring parameter information about the I2C link; and packing and virtualizing the parameter information and the I2C link to obtain a virtualized device parameter and the virtual device.

In some embodiments, acquiring parameter information about the I2C link includes: acquiring parameter information about an internal state of the I2C link, including operating modes, timing sequence parameters for different operating modes, and a transmission state of a data bus; and acquiring parameter information about an external circuit of the I2C link, including a bus transmission rate, pin configuration and external pull-up resistor conditions, presence conditions of slave devices, and a running state of an I2C SWITCH in case of multiple slave devices.

In some embodiments, the step of establishing the cascade between the virtual device and the virtual machine, controlling, by the virtual machine, the virtual device to undergo the verification, and acquiring the initial state number corresponding to the virtual device in response to having passed the verification includes: storing the virtualized device parameter in the virtual machine; performing cascade classification according to a data transmission capability parameter of the virtual device and a function of a device connected to the I2C link to establish the cascade between the virtual machine and the virtual device; and verifying the virtual device by the virtual machine based on the cascade, and acquiring the initial state number corresponding to the virtual device when the virtual machine matches the virtual device.

In some embodiments, the step of verifying the virtual device by the virtual machine based on the cascade, and acquiring the initial state number corresponding to the virtual device when the virtual machine matches the virtual device includes: setting a period for verifying the virtual device by the virtual machine, and determining whether the parameter of the virtual device satisfies a required index within the period; adjusting the parameter of the virtual device in response to the parameter of the virtual device not satisfying the required index; and assigning a corresponding state parameter number to the virtual device as the initial state number in response to the parameter of the virtual device satisfying the required index.

In some embodiments, the step of setting a period for verifying the virtual device by the virtual machine, and determining whether the parameter of the virtual device satisfies a required index within the setting includes: determining whether a machine-side link signal of the I2C link is in place; and determining whether the transmission rate of the I2C link matches the transmission rate of a current mode.

In some embodiments, the step of obtaining an updated state by updating the state of the virtual device according to changes of the virtual device occurred during operation of the virtual device includes: acquiring the virtualized device parameter corresponding to the virtual device during running in real time and taking the virtualized device parameter as an operation parameter of the virtual device; and obtaining the updated state by updating the state of the virtual device based on a change of the operation parameter.

In some embodiments, the step of managing the initial state number, adding an offset corresponding to the updated state and recording the offset, and establishing a response of the virtual machine to the offset corresponding to the updated state to manage the I2C link includes: creating a state number management unit to manage various updated states of the virtual device; and establishing responses of the virtual machine to offsets corresponding to various updated states of the virtual device to manage the I2C link.

In some embodiments, the step of creating a state number management unit to manage various updated states of the virtual device includes: providing an offset unit for abnormities during operation and an offset unit for states during operation in the state number management unit to respectively match an abnormal updated state and a normal updated state of the virtual device.

In some embodiments, the step of creating a state number management unit to manage various updated states of the virtual device further includes: updating a state offset in the offset unit for states during operation in response to the updated state of the virtual device being the normal updated state; in response to the updated state of the virtual device being a known abnormal updated state, addressing an abnormal offset corresponding to the known abnormal updated state in the offset unit for abnormities and executing a corresponding processing measure.

In some embodiments, the step of creating a state number management unit to manage various updated states of the virtual device further includes: updating and recording the abnormal offset in the offset unit for abnormities during operation in response to the updated state of the virtual device being an unknown abnormal updated state.

In some embodiments, the step of updating and recording the abnormal offset in the offset unit for abnormities during operation in response to the updated state of the virtual device being an unknown abnormal updated state includes: recording the updated abnormal offset in the offset unit for abnormities, and providing a corresponding abnormal offset for the virtual device in the same abnormal updated state; and recording the updated abnormal offset in a pre-operation abnormity unit to avoid the occurrence of the abnormal updated state of the virtual device prior to the operation.

Finally, it should be noted that those skilled in the art can understand the implementation of all or part of the processes in the above method embodiments can be accomplished by instructing relevant hardware through a computer program. The method of setting system parameters can be stored in a computer readable storage medium. When the program is executed, it may include the processes of the various methods described above. The storage medium for the program may be a magnetic disk, an optical disk, a read-only memory (ROM), or a random access memory (RAM), etc. The implementation of the above-mentioned computer program can achieve the same or similar effects as any of the aforementioned method implementations.

Furthermore, the method provided by some embodiments of the present disclosure can also be implemented as a computer program executed by a processor, and the computer program can be stored in a non-transitory computer readable storage medium. When the computer program is executed by the processor, functions defined in the method provided by some embodiments of the present disclosure are executed.

Furthermore, the aforementioned method steps and system units can also be implemented using a controller and a non-transitory computer readable storage medium that is stored with a computer program enabling the controller to realize the aforementioned steps or unit functions.

It will also be understood by those skilled in the art that the various exemplary logic blocks, modules, circuits, and algorithmic steps described here can be implemented as electronic hardware, computer software, or a combination of both. To clearly illustrate the interchangeability between hardware and software, a general description has been given for the functions of various illustrative components, blocks, modules, circuits, and steps. Whether the function is realized as software or as hardware depends on the specific application and the design constraints imposed on the entire system. Those skilled in the art can implement the function in various ways for each specific application, but such implementation decision should not be interpreted as departing from the scope of some embodiments disclosed in the disclosure.

In one or more exemplary designs, the functionality can be implemented in hardware, software, firmware, or any combination thereof. If implemented in software, the functionality can be stored as one or more instructions or codes on a computer readable medium or transmitted via a computer readable medium. The computer readable media include computer storage media and communication media, which includes any medium that facilitates the transfer of computer programs from one location to another. The storage medium can be any available medium accessible by a general or special-purpose computer. By way of example and not limitation, the computer readable medium may include RAM, ROM, EEPROM, CD-ROM, or other optical disk storage devices, magnetic disk storage devices, or any other medium that carries or stores the required program code in the form of instructions or data structures and is accessible by a general or special-purpose computer or processor. Additionally, any connection can appropriately be referred to as a computer readable medium. For instance, if software is sent from a website, server, or other remote source using coaxial cables, fiber-optic cables, twisted pair, digital subscriber lines (DSL), or wireless technologies such as infrared, radio, and microwave, then the aforementioned coaxial cables, fiber-optic cables, twisted pair, DSL, or wireless technologies such as infrared, radio, and microwave are included in the definition of the medium. As used here, disks and discs include CDs, laser discs, discs, digital versatile discs (DVDs), floppy disks, Blu-ray discs, where disks typically magnetically reproduce data, and discs use laser optics to reproduce data. The combination of the above should also be included within the scope of computer readable media.

The above is exemplary embodiments of the present disclosure, but it should be noted that various changes and modifications can be made without departing from the scope of the disclosure as defined by the claims. The functions, steps, and/or actions of the method claims described in the exemplary embodiment here do not need to be performed in any particular order. Furthermore, although an element of some embodiments of the present disclosure may be described or claimed as singular, they can also be understood as multiple unless explicitly limited to the singular.

It should be understood that, unless the context clearly supports an exception, the singular form “one” is intended to include the plural form as well. It should also be understood that the term “and/or” used herein means to include any and all possible combinations of one or more of the items listed in association.

The serial numbers of some embodiments of the disclosure are merely for description and do not represent the superiority or inferiority of the embodiments.

Those skilled in the art should understand that all or part of the steps of the above embodiments can be accomplished by hardware, or by instructing the relevant hardware through a program, and the program can be stored in a non-transitory computer readable storage medium, the storage medium mentioned above can be a read-only memory, a magnetic disk, or an optical disk and the like.

Those skilled in the art should understand that any embodiment described above is only exemplary and is not intended to imply that the scope of some embodiments of the disclosure (including claims) is limited to these embodiments. Under the concept of some embodiments of the disclosure, the technical features in the above embodiments or different embodiments can also be combined, and there are many other variations of different aspects of the application, which are not provided in detail for the sake of brevity. Therefore, any omissions, modifications, equivalent substitutions, improvements, etc., made within the spirit and principles of some embodiments, should be included within the scope of protection of the disclosure.

1. A method for managing an Inter-Integrated Circuit (I2C) link, comprising:
obtaining a corresponding virtual device by packing and virtualizing the I2C link;
establishing a cascade between the virtual device and a virtual machine, controlling, by the virtual machine, the virtual device to undergo verification, and acquiring an initial state number corresponding to the virtual device in response to having passed the verification;
updating a state of the virtual device according to changes of the virtual device occurred during operation of the virtual device, and obtaining an updated state; and
managing the initial state number, adding an offset corresponding to the updated state and recording the offset, and establishing a response of the virtual machine to the offset corresponding to the updated state to manage the I2C link.

2. The method according to claim 1, wherein the step of obtaining a corresponding virtual device by packing and virtualizing the I2C link comprises:
acquiring parameter information about the I2C link; and
packing and virtualizing the parameter information and the I2C link to obtain a virtualized device parameter and the virtual device.

3. The method according to claim 2, wherein the step of acquiring parameter information about the I2C link comprises:
acquiring parameter information about an internal state of the I2C link, including operating modes, timing sequence parameters for various operating modes, and a transmission state of a data bus; and
acquiring parameter information about an external circuit of the I2C link, including a bus transmission rate, pin configuration and external pull-up resistor conditions, presence conditions of slave devices, and a running state of an I2C SWITCH in case of multiple slave devices.

4. The method according to claim 3, further comprising:
creating the virtual machine by a preset baseboard management controller (BMC) unit.

5. The method according to claim 4, further comprising:
detecting and controlling, by the virtual machine, the virtual device to monitor parameter information about the virtual device.

6. The method according to claim 2, wherein the step of establishing a cascade between the virtual device and a virtual machine, controlling, by the virtual machine, the virtual device to undergo verification, and acquiring an initial state number corresponding to the virtual device in response to having passed the verification comprises:
storing the virtualized device parameter in the virtual machine;
performing cascade classification according to a data transmission capability parameter of the virtual device and a function of a device connected to the I2C link to establish the cascade between the virtual machine and the virtual device; and
verifying, by the virtual machine, the virtual device based on the cascade, and acquiring the initial state number corresponding to the virtual device in response to the virtual machine matching the virtual device.

7. The method according to claim 6, wherein the step of verifying, by the virtual machine, the virtual device based on the cascade, and acquiring the initial state number corresponding to the virtual device in response to the virtual machine matching the virtual device comprises:
setting a period for verifying the virtual device by the virtual machine, and determining whether a parameter of the virtual device satisfies a required index within the period;
adjusting the parameter of the virtual device in response to the parameter of the virtual device not satisfying the required index; and
assigning a corresponding state parameter number to the virtual device as the initial state number in response to the parameter of the virtual device satisfying the required index.

8. The method according to claim 7, wherein the step of setting a period for verifying the virtual device by the virtual machine, and determining whether a parameter of the virtual device satisfies a required index within the period comprises:
determining whether a machine-side link signal of the I2C link is in place; and
determining whether a transmission rate of the I2C link matches a transmission rate of a current mode.

9. The method according to claim 2, wherein the step of updating a state of the virtual device according to changes of the virtual device occurred during operation of the virtual device, and obtaining an updated state comprises:
acquiring a corresponding virtualized device parameter during the operation of the virtual device in real time, and taking the virtualized device parameter as an operation parameter of the virtual device; and
updating the state of the virtual device based on changes of the operation parameter to obtain the updated state.

10. The method according to claim 9, further comprising:
comparing the operation parameter with a preset parameter; and
adjusting the operation parameter of the virtual device to allow the virtual device to operate normally.

11. The method according to claim 10, further comprising:
assigning, by the virtual machine, a state offset to the virtual device having the adjusted parameter.

12. The method according to claim 11, further comprising:
in response to an abnormity in the virtual device, recording, by the virtual machine, a state offset under the abnormity.

13. The method according to claim 1, wherein the step of managing the initial state number, adding an offset corresponding to the updated state and recording the offset, and establishing a response of the virtual machine to the offset corresponding to the updated state to manage the I2C link comprises:
creating a state number management unit to manage various updated states of the virtual device; and
establishing responses of the virtual machine to offsets corresponding to various updated states of the virtual device to manage the I2C link.

14. The method according to claim 13, wherein the step of creating a state number management unit to manage various updated states of the virtual device comprises:
providing, in the state number management unit, an offset unit for abnormities during operation and an offset unit for states during operation to respectively match an abnormal updated state and a normal updated state of the virtual device.

15. The method according to claim 14, wherein the step of creating a state number management unit to manage various updated states of the virtual device further comprises:
updating a state offset in the offset unit for states during operation in response to the updated state of the virtual device being the normal updated state; and
in response to the updated state of the virtual device being a known abnormal updated state, addressing an abnormal offset corresponding to the known abnormal updated state in the offset unit for abnormities, and executing a corresponding processing measure.

16. The method according to claim 15, wherein the step of creating a state number management unit to manage various updated states of the virtual device further comprises:
in response to the updated state of the virtual device being an unknown abnormal updated state, updating the abnormal offset in the offset unit for abnormities during operation and recording the abnormal offset.

17. The method according to claim 16, wherein the step of in response to the updated state of the virtual device being an unknown abnormal updated state, updating the abnormal offset in the offset unit for abnormities during operation and recording the abnormal offset comprises:
recording the updated abnormal offset in the offset unit for abnormities, and providing a corresponding abnormal offset for the virtual device in the same abnormal updated state; and
recording the updated abnormal offset in a pre-operation abnormity unit to avoid the occurrence of the abnormal updated state of the virtual device prior to the operation.

18. (canceled)

19. A computer device, comprising:
at least one processor; and
a memory storing computer instructions executable on the processor, wherein the instructions, when executed by the processor, implement operations of:
obtaining a corresponding virtual device by packing and virtualizing an Inter-Integrated Circuit (I2C) link;
establishing a cascade between the virtual device and a virtual machine, controlling, by the virtual machine, the virtual device to undergo verification, and acquiring an initial state number corresponding to the virtual device in response to having passed the verification;
updating a state of the virtual device according to changes of the virtual device occurred during operation of the virtual device, and obtaining an updated state; and
managing the initial state number, adding an offset corresponding to the updated state and recording the offset, and establishing a response of the virtual machine to the offset corresponding to the updated state to manage the I2C link.

20. A non-transitory computer readable storage medium storing a computer program that, when executed by a processor, implements operations of:
obtaining a corresponding virtual device by packing and virtualizing an Inter-Integrated Circuit (I2C) link;
establishing a cascade between the virtual device and a virtual machine, controlling, by the virtual machine, the virtual device to undergo verification, and acquiring an initial state number corresponding to the virtual device in response to having passed the verification;
updating a state of the virtual device according to changes of the virtual device occurred during operation of the virtual device, and obtaining an updated state; and
managing the initial state number, adding an offset corresponding to the updated state and recording the offset, and establishing a response of the virtual machine to the offset corresponding to the updated state to manage the I2C link.

21. The computer device according to claim 19, wherein the step of obtaining a corresponding virtual device by packing and virtualizing the I2C link comprises:
acquiring parameter information about the I2C link; and
packing and virtualizing the parameter information and the I2C link to obtain a virtualized device parameter and the virtual device.
